(19) United States
(12) Patent Application Publication
(10) Pub. No.: US 2002/0165722 A1
(43) Pub. Date: Nov. 7, 2002

(54) Motor vehicle allocation swapping method

(76) Inventor: Ryan Luddy, Holden, MA (US)

Correspondence Address: Brian M. Dingman, Mlrick, O'Connell, 100 Front Street, Worcester, MA, 01608, US

(21) Appl. No.: 09/729,621

(22) Filed: Nov. 29, 2000

Related U.S. Application Data
(60) Provisional application No. 60/167,719, filed on Nov. 29, 1999.

(51) Int. Cl. G06F 17/60

(52) U.S. Cl. 705/1

(57) ABSTRACT

A motor vehicle allocation swapping method, comprising: providing a web site through which the swaps are enabled; allowing a user of the web site to post a vehicle for trade to another dealer; maintaining a database of posted vehicles; and allowing a user to search the database of posted vehicles, to allow the users to contact one another to arrange for a trade of the vehicles. Preferably, the users are also allowed to post a vehicle they desire to trade for.

### CROSS-REFERENCE TO RELATED APPLICATION

This application claims priority of Provisional application serial No. 60/167,719, filed on Nov. 29, 1999.

### FIELD OF THE INVENTION

The invention is a means to facilitate swapping by motor vehicle dealers of their new vehicle allocation(s) from the manufacturer, before the order is placed with the manufacturer.

### BACKGROUND OF THE INVENTION

Motor vehicle dealers are periodically allocated quantities of the several models by a particular manufacturer. These allocations are usually based on the dealer's previous sales history. However, the allocation does not always match the desired customer purchases for that time frame. This mismatch causes lost sales and/or additional work by the dealer in an attempt to locate a desired vehicle at another dealer, and then a negotiation to obtain the vehicle from the other dealer, and have it shipped, all in a timely fashion.

### SUMMARY OF THE INVENTION

It is therefore a primary object of this invention to provide a means that allows motor vehicle dealers to trade product allocations between themselves before product orders are placed with the manufacturer. This allows the manufacturer to still build the number and type of units that they had planned, while allowing the dealers to better serve the particular needs of their customers at any given time.

This invention features a motor vehicle allocation swapping method, comprising: providing a web site through which the swaps are enabled; allowing a user of the web site to post a vehicle for trade to another dealer; maintaining a database of posted vehicles; and allowing a user to search the database of posted vehicles, to allow the users to contact one another to arrange for a trade of the vehicles. Preferably, the users are also allowed to post a vehicle they desire to trade for.

### BRIEF DESCRIPTION OF THE DRAWINGS

Other objects, features and advantages will occur to those skilled in the art from the following description of the preferred embodiments, and the accompanying drawings, in which:

FIG. 1 is a view of the home page for a web site implementing this invention;

FIG. 2 is a simplified view of the log-in screen for the web site of FIG. 1;

FIG. 3 is a simplified view of the welcome screen that follows the log-in screen of FIG. 2;

FIG. 4 is a simplified view of the vehicle make selection screen that follows the screen of FIG. 3;

FIG. 5 is a view of the following screen that provides information and choices for further use of the web site;

FIG. 6 is the screen that is used to post an allocation for trade when such is selected from the screen shown in FIG. 5;

FIG. 7 is the confirmation screen that appears when a user posts and allocation for trade using the screen of FIG. 6;

FIG. 8. is a screen that allows for searching of vehicles that have been previously posted for trade allocation; and

FIG. 9 shows results of a search accomplished by the screen of FIG. 8.

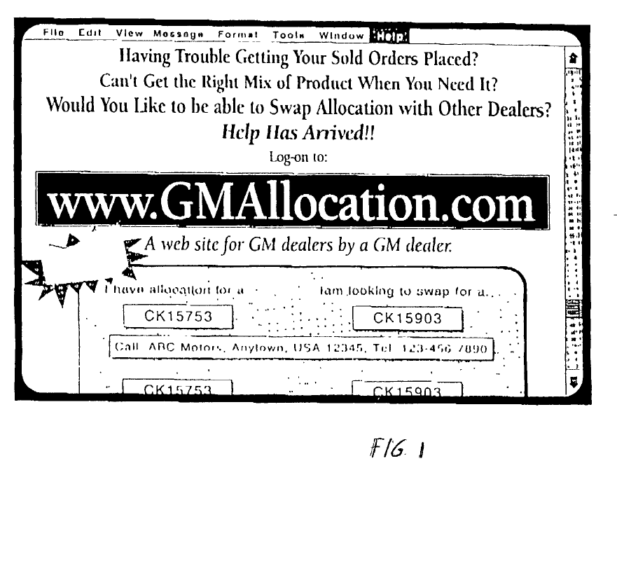

### DESCRIPTION OF THE PREFERRED EMBODIMENT

The preferred embodiment is shown in the attached drawings, which are mock ups of pages of a web site, which is the preferred means of implementing the invention. The web site allows dealers to communicate with one another any time. It would be used as follows.

Dealers could post vehicles that they desire to swap, and/or search for vehicles they need. The server maintains a searchable database with the posted information. Typically, the dealer will post an allocation it does not want, and offer to trade it for a vehicle it needs (typically, to fill a pending order). Another dealer then can go to the site and search for available vehicles, and then separately contact a listing dealer to arrange a swap or purchase of the offered vehicle, or perhaps a different vehicle. The search engine allows a dealer to search only in listed states or geographic areas, if desired.

In order to consummate a swap of allocated vehicles, each dealer agrees to place the other's sold order with their allocation that then goes to the manufacturer. The dealer fills in the “ship to” code in the allocation with the other dealer's address. This way, the vehicles being swapped are shipped by the manufacturer directly to the dealers that want the vehicles. This saves the dealers from having to physically ship or transport the vehicles themselves, all the while maintaining the manufacturer's allocation system unchanged.

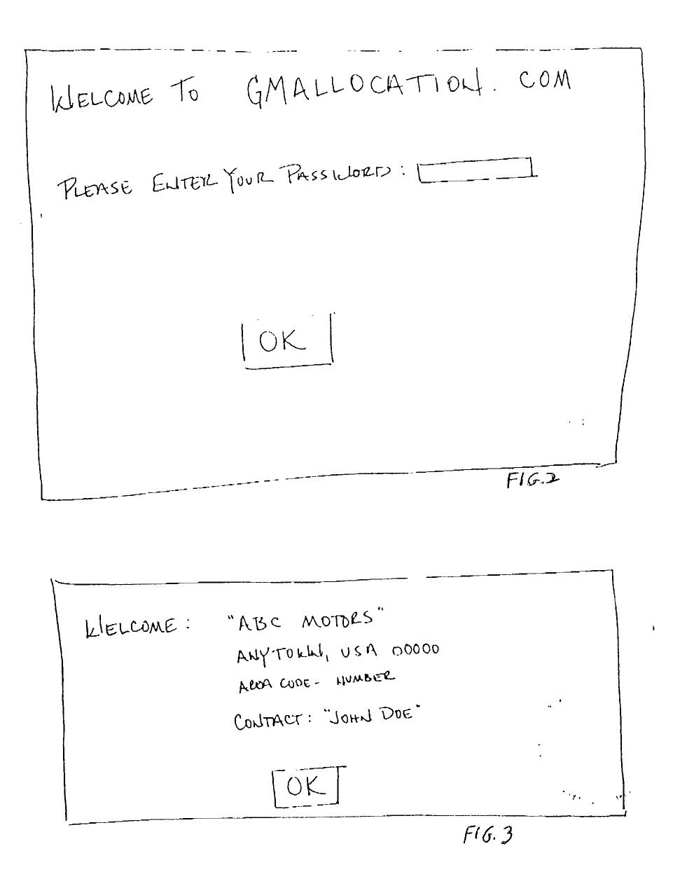

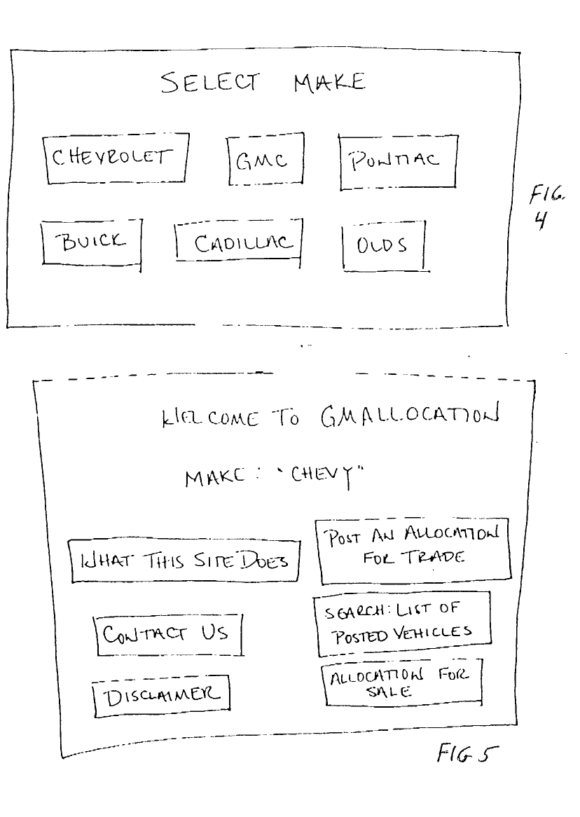

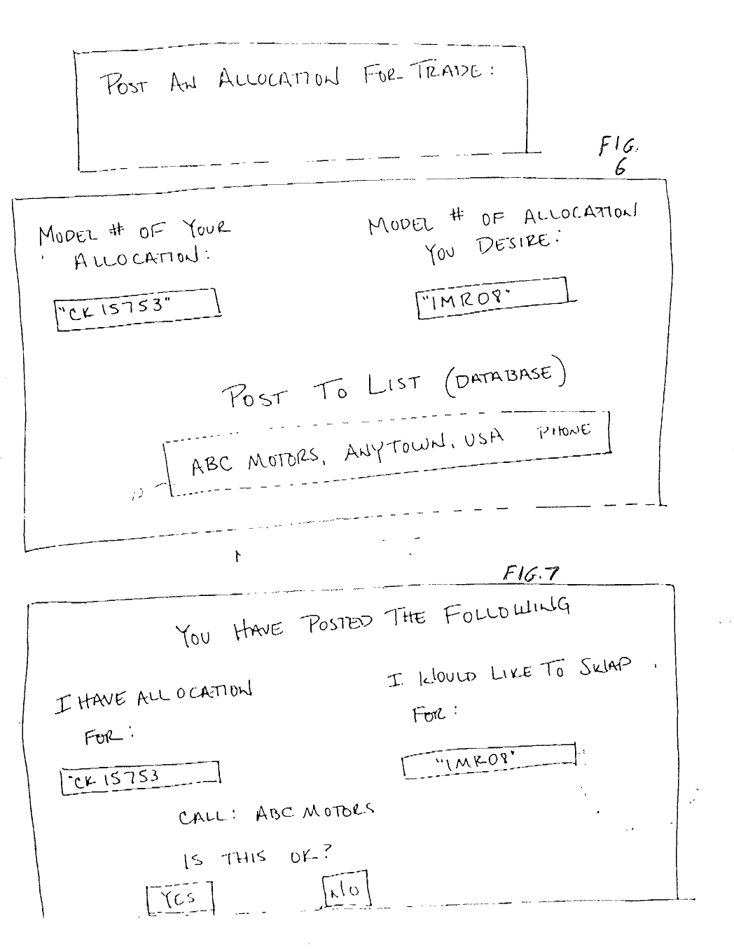

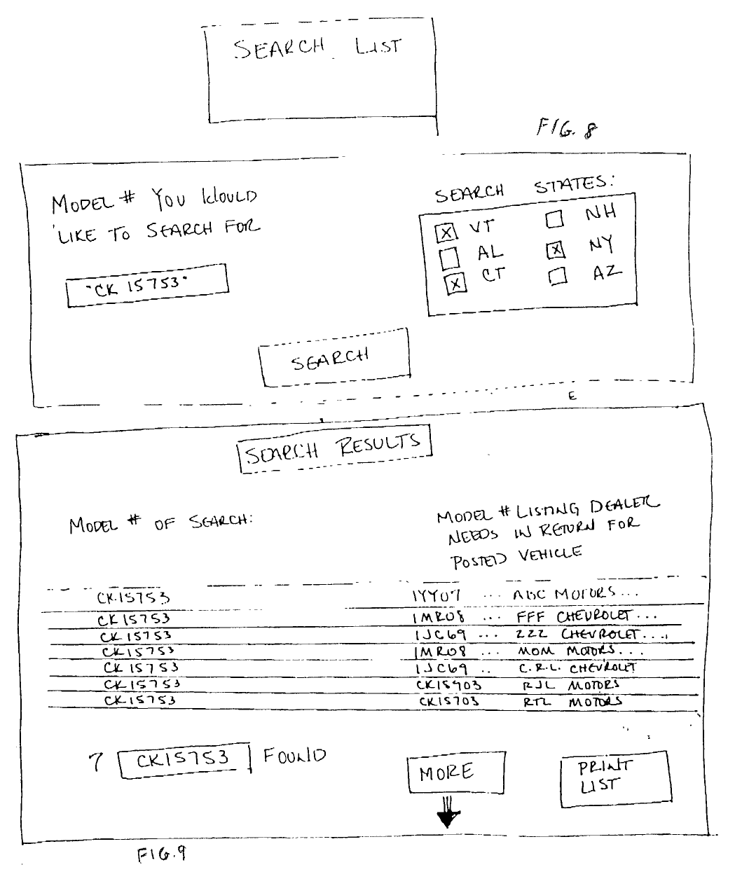

FIG. 2 shows a log-in screen that illustrates that the web site of the invention is password-controlled. This helps to insure that only authorized users are using the web site, and is also a means for the web server to track transactions by user, for historical purposes and potentially also for billing purposes. The welcome screen shown in FIG. 3 verifies to the user that they have properly logged in. When the button is clicked, the make selection screen of FIG. 4 may be the next screen. This allows the user to either post a particular make for allocation, or search for available allocations by make. After a make is selected, the welcome screen for each make appears, shown in FIG. 5. The three buttons on the right hand side of the figure are the possible choices for actual use of the site. These allow the user to post an allocation for trade, to search through already posted vehicles, or to post an allocation for sale as opposed to trade, or search for a vehicles that have been posted for sale. Primarily, this invention relates to the vehicle swapping that would be accomplished by use of the first two of these three described choices.

When the “post an allocation for trade” button is pressed, the post screen of FIG. 6 appears. The user simply types in the model number of its allocation and the model number of an allocation it desires to swap for. The user identification in lower block 12 can be automatically filled in by the server based on the log-in information. The confirmation screen is shown in FIG. 7. This allows the user to insure that the posting is correct. When the yes button is clicked, the data is entered into a simple database maintained by the server.

This database is searchable using the search screen shown in FIG. 8, and the search results shown in FIG. 9. The search is accomplished by model number. Other filters can be applied to the search, for example geography. Clicking the search button causes the server to query the database and display results matching the searched fields as shown in FIG. 9. The user would check the model number the listing dealer needs in return for the posted vehicle to determine whether the user desires to trade its allocation for the desired vehicle for the model number searched. If so, the user would contact the listing dealer by any convenient means. Typically, the search results would display the preferred contact means as established by the users, for example by telephone, fax, or internet. When a trade is made, the server would be enabled to delete the allocation posting from the database to maintained the currency of the database. This could be accomplished by an allocation deletion screen, not shown in the drawings, which would be very similar to the screen shown in FIG. 6. This feature also allows a user to withdraw a posted allocation at any time if, for example, the dealer ends up selling a posted vehicle before another dealer indicates a desire to swap for it.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A motor vehicle allocation swapping method, comprising:
providing a web site through which the swaps are enabled;
allowing a user of the web site to post a vehicle for trade to another dealer;
maintaining a database of posted vehicles; and
allowing a user to search the database of posted vehicles, to allow the users to contact one another to arrange for a trade of the vehicles.

2. The method of claim 1, wherein the users are also allowed to post a vehicle they desire to trade for.
